(19) United States
(12) Patent Application Publication
(10) Pub. No.: US 2017/0341211 A1
(43) Pub. Date: Nov. 30, 2017

(54) NAILING DEVICE

(71) Applicant: HILTI AKTIENGESELLSCHAFT, Schaan (LI)

(72) Inventors: Karl FRANZ, Oppenweiler (DE); Joerg STAMM, Buchs SG (CH); Roland SCHNEIDER, Moritzburg (DE); Emanuel KURTH, Chur (CH)

(21) Appl. No.: 15/536,577

(22) PCT Filed: Dec. 22, 2015
(86) PCT No.: PCT/EP2015/081018

§ 371 Date: Jun. 15, 2017

(30) Foreign Application Priority Data
Dec. 23, 2014 (EP) 14199960.7

(51) Int. Cl. B25C 7/00; B25C 1/00

(52) U.S. Cl. CPC B25C 7/00; B25C 1/001; B25C 1/008

(57) ABSTRACT

The invention relates to a nail device for setting nails into an object, comprising a housing, a setting mechanism for setting the nail along a setting axis, a bolt-guiding element for contacting on the object at a first contact point, in particular a trigger for activating the setting mechanism, a swivelable support foot for contacting on the object at a second contact point, wherein a connecting line between the first and the second contact point and the setting axis span a device plane of the nail device, characterised in that the swivel axis of the support foot is oriented substantially perpendicular to the device plane.

The present invention relates to a nailing device for setting nails into an object.

Nailing devices are used in particular in the construction industry to introduce nails, bolts, pins, staples, or other fasteners into an object or substrate made of wood, concrete, or steel, for example. The nailing devices are generally driven pneumatically, electrically, or by combustion, in particular powder or gas combustion. A nail magazine is used for storing a fairly large number of nails or staples.

A nailing device is known from DE 10 2012 212 674 A1, comprising a housing, a setting mechanism for setting the nails along a setting axis, a bolt-guiding element for placement on the object at a first contact point, a trigger for activating the setting mechanism, a pivotable support foot for placement on the object at a second contact point, wherein a connecting line between the first and the second contact point, and the setting axis span a device plane of the nailing device. The support foot is provided with two support elements, thus ensuring a perpendicular orientation of the nailing device with respect to the substrate and thus, perpendicular driving of the nails into the substrate. The pivot axis lies in the device plane and is parallel to the setting axis, so that the support elements in a first pivot position of the support foot together with the bolt-guiding element form a triangle for a three-point support of the nailing device, and in a second pivot position of the support foot are intersected by the device plane. In both pivot positions, the support foot protrudes from the remainder of the nailing device in the direction of the setting axis.

The object of the present invention is to provide a nailing device, having a support foot, which provides improved access to confined areas for a setting.

This object is achieved with a nailing device for setting nails into an object, comprising a housing, a setting mechanism for setting the nails along a setting axis, a bolt-guiding element for placement on the object at a first contact point, in particular a trigger for activating the setting mechanism, a pivotable support foot for placement on the object at a second contact point, wherein a connecting line between the first and the second contact point, and the setting axis span a device plane of the nailing device, characterized in that the pivot axis of the support foot is oriented essentially perpendicularly with respect to the device plane. The support foot is preferably pivotable about the pivot axis by at least 180°. The support foot may thus in particular be completely swiveled out of the area between the remainder of the nailing device and the object, so that in this swiveled-out pivot position of the support foot, the nailing device is also usable in less accessible areas. The bolt-guiding element is preferably used for guiding the nails, bolts, pins, or staples during setting or introduction into the object.

One preferred embodiment is characterized in that the support foot is provided with two support elements for a two-point support, so that the nailing device together with the bolt-guiding element has a three-point support. The two support elements are preferably situated at a distance from the device plane. The bolt-guiding element forms the first point bearing, and the two support elements on the support foot form the two, second and third point bearings for the nailing device. At least for an object having an essentially flat surface, the bolt-guiding element and thus the setting axis may be oriented essentially perpendicularly with respect to the object plane by means of the three-point support. The two support elements are preferably situated at the same distance from the pivot axis. In an alternative embodiment, the two support elements are situated at different distances from the pivot axis. The two support elements, in particular in the end area of the support elements, are preferably made, at least partially, in particular completely, of an elastomer or rubber. The contact areas of the support elements then ensure a particularly secure hold of the nailing device, in particular against shifting on the surface of the object.

One preferred embodiment is characterized in that the support foot is fixable and detachable in at least one pivot position. The support foot is preferably lockable and unlockable in the pivot position.

One preferred embodiment is characterized in that the support foot together with an overload mechanism is fastened to the remainder of the nailing device, so that when a force that exceeds an overload force is applied to the support foot, the support foot is automatically detachable from the remainder of the nailing device. The overload mechanism is preferably formed by the pivot mechanism.

The nailing device preferably also comprises a nail magazine that connects the bolt-guiding element to the support foot. A pivot bearing which defines the pivot axis of the support foot is preferably situated on the nail magazine. The pivot bearing is particularly preferably fastened to the nail magazine. The pivot bearing is preferably situated at an end of the nail magazine remote from the bolt-guiding element. It is likewise preferred that the support foot is situated at an end of the nail magazine remote from the bolt-guiding element.

The nailing device also preferably comprises a frame hook which is pivotable together with the support foot about the pivot axis of the latter. The frame hook is particularly preferably fixedly connected to the support foot.

The support foot preferably protrudes from the housing, or optionally from the nail magazine. In preferred variants, the support foot protrudes from a fuel container holder, such as a gas can compartment, or a battery holder or a handle or a handle extension.

The two support elements that form the two-point support on the support foot are preferably spaced apart from one another by at least 1 cm, 3 cm, 5 cm, or 10 cm. Tilting of the nailing device is thus more difficult. In another embodiment, the two support elements are spaced apart from the bolt-guiding element by at least 5 cm, 10 cm, 20 cm, or 30 cm.

The support foot together with a pivot mechanism is preferably fastened to and supported on the remainder of the nailing device, and together with the pivot mechanism, in the first and second pivot positions is fixable and detachable, in particular lockable and unlockable, in particular by moving the support foot parallel to the pivot axis. When a force or movement is applied to the support foot essentially parallel to the pivot axis of the support foot, in the two pivot positions the support foot may be fastened to and detached from the remainder of the nailing device. Particularly simple fixing of the support foot in the two pivot positions is thus ensured. The support foot is preferably detachably fastened to the remainder of the nailing device, and is brought from a first pivot position into a second pivot position by complete detachment from the remainder of the nailing device.

In another embodiment, the support foot is fastened to an overload mechanism on the remainder of the nailing device, so that when a force that exceeds an overload force is applied to the support foot, the support foot is automatically detachable from the remainder of the nailing device; in particular, the overload mechanism is formed by the pivot mechanism. In actual use, the nailing device may also fall, for example, with the supporting foot thereby striking the object. The overload mechanism ensures that if an overload force is exceeded, the connection between the support foot and the remainder of the nailing device is independently and automatically detached via the overload mechanism, thus reducing the risk of damage to the support foot or to the device.

In another embodiment, the setting mechanism is operable electrically, pneumatically, or by combustion, the fuel being in particular solid, liquid, or gaseous. The nailing device particularly preferably includes a battery, for example for an electrically operated setting mechanism. For a setting mechanism that is operated by combustion, the nailing device preferably includes a fuel cartridge, in particular in the form of a cartridge strip or a gas can.

In a further embodiment, the housing of the nailing device is made at least partially, preferably completely, of metal and/or plastic. The support foot preferably includes plastic, which particularly preferably is fiber-reinforced, as material.

Exemplary embodiments of the invention are described in greater detail below with reference to the appended drawings, which show the following:

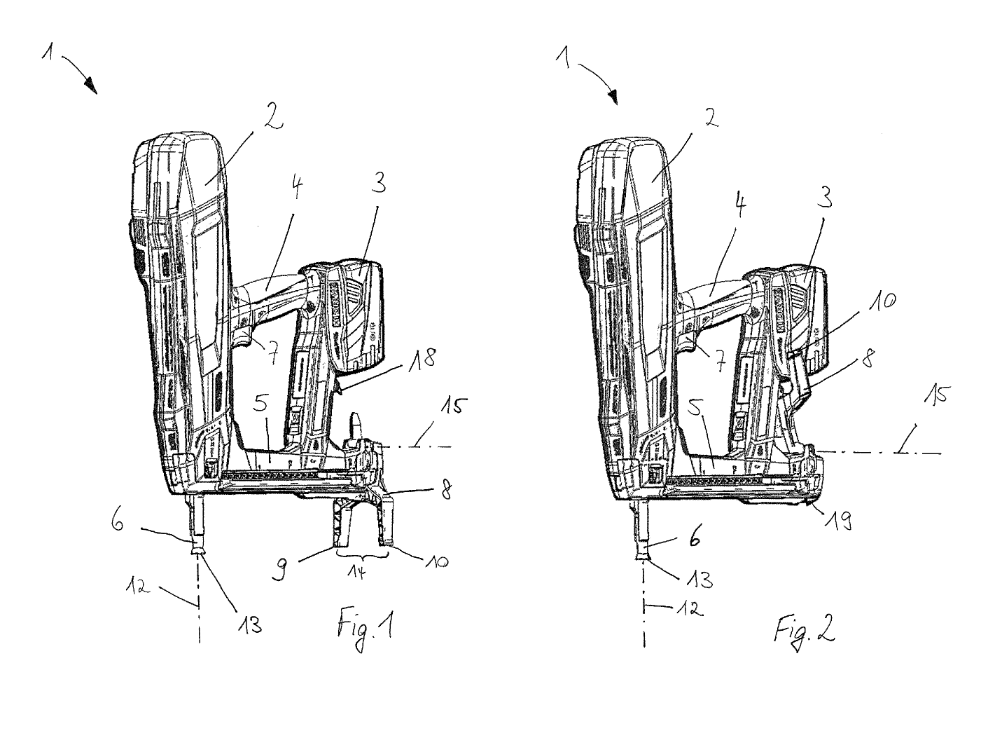

FIG. 1 shows an oblique view of a nailing device, with a support foot in a first pivot position,

FIG. 2 shows an oblique view of a nailing device, with a support foot in a second pivot position,

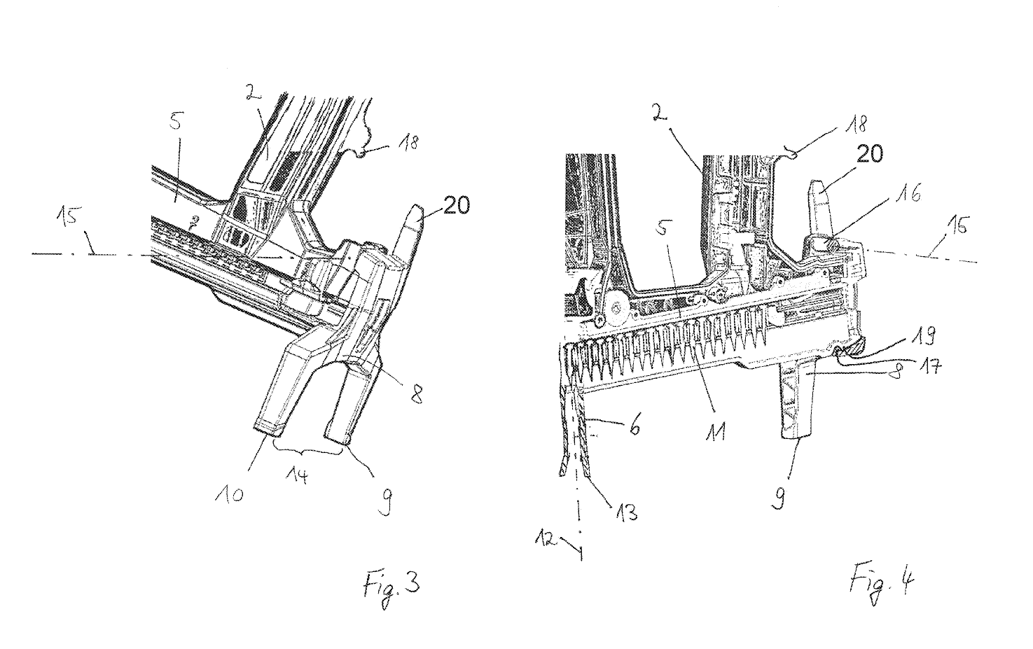

FIG. 3 shows a partial view of a nailing device, and

FIG. 4 shows a sectional view of a nailing device.

FIGS. 1 through 4 show a nailing device 1 that is used to drive nails 11 into an object or substrate (not illustrated) made of wood, concrete, or steel, for example. To this end, the nailing device 1 has a housing 2, made of metal and/or plastic, which generally has multiple parts. A setting mechanism (not illustrated) which is electrically operated by a battery 3 is situated inside the housing 2. A portion of the housing 2 forms a nail magazine 5. The nail magazine 5 contains a large number of nails 11, and for setting the nails, the nails are conveyed from the nail magazine 5 to the setting mechanism, and by means of the setting mechanism which is activated by a trigger, are driven into the object, using a bolt-guiding element 6 as an integral part of the setting mechanism. The bolt-guiding element 6 has a longitudinal axis which forms a setting axis 12 of the nailing device 1. For holding the nailing device 1, the housing 2 is designed in such a way that it also includes a handle 4 for holding the nailing device 1. The outermost end of the bolt-guiding element 6 forms a first contact point on the object. The bolt-guiding element is used for guiding the nails 11 during setting or introduction into the object.

The nailing device has a support foot 8 with a first support element 9 and a second support element 10 for placement on the object, the first support element 9 and the second support element 10 together forming a second contact point 14. A connecting line between the first contact point 13 and the second contact point 14, and the setting axis 12 span a device plane of the nailing device. The support foot 8 has a pivotable design, and for this purpose has a pivot bearing 16 which defines a pivot axis 15 that is oriented perpendicularly with respect to the device plane. The support foot 8 is pivotable about the pivot axis 15 by somewhat more than 180°. The support foot 8 may thus be completely swiveled out of the area between the remainder of the nailing device 1 and the object, so that the nailing device is also usable in less accessible areas. The pivot bearing 16 and the support foot 8 are situated at an end of the nail magazine 5 remote from the bolt-guiding element 6. The support foot 8 is fastened to the pivot bearing 16 by means of a snap connection, so that the support foot 8 automatically detaches from the pivot bearing 16 when a force that exceeds an overload force is applied to the support foot 8. The pivot mechanism thus provides overload protection for the support foot 8.

FIGS. 1, 3, and 4 illustrate the support foot 8 in its first pivot position, in which it is locked to the magazine 5 of the housing 2 and to a locking tab 17 of the support foot 8 by means of a first locking projection 19. The first support element 9 and the second support element 10 together with the bolt-guiding element 6 thus form a three-point support for the nailing device 1 on the object. For this purpose, the two support elements 9, 10 are situated on opposite sides of the device plane, at a distance therefrom. The bolt-guiding element 6 forms the first point bearing, and the two support elements 9, 10 on the support foot 8 form the two, second and third point bearings for the nailing device 1. In this way, the setting axis 12 may be oriented perpendicularly with respect to the surface of the object. The end areas of the support elements are made of rubber and are therefore slip-resistant.

FIG. 2 illustrates the support foot 8 in its second pivot position, in which it is locked to the magazine 5 of the housing 2 and to the locking tab 17 of the support foot 8 by means of a second locking projection 18. In exemplary embodiments that are not illustrated, the support foot has a second locking tab for this purpose. In addition, the nailing device 1 includes a frame hook 20 that has a one-piece design with the support foot 8 and is thus pivotable about the pivot axis 15. In the first pivot position of the support foot, the nailing device 1 is easily suspendable in a frame tube or the like by means of the frame hook 20.

1. A nailing device for setting nails into an object, comprising a housing, a setting mechanism for setting the nails along a setting axis, a bolt-guiding element for placement on the object at a first contact point, a pivotable support foot for placement on the object at a second contact point, wherein a connecting line between the first and the second contact point, and the setting axis span a device plane of the nailing device, wherein a pivot axis of the support foot is oriented essentially perpendicularly with respect to the device plane.

2. The nailing device according to claim 1, wherein the support foot comprises two support elements for a two-point support, so that the nailing device together with the bolt-guiding element has a three-point support.

3. The nailing device according to claim 2, wherein the two support elements are situated at a distance from the device plane.

4. The nailing device according to claim 1, wherein the support foot is fixable and detachable, in at least one pivot position.

5. The nailing device according to claim 1, further comprising an overload mechanism comprising a pivot mechanism, wherein the support foot together with the overload mechanism is fastened to the nailing device, so that when a force that exceeds an overload force is applied to the support foot, the support foot is automatically detachable from the nailing device.

6. The nailing device according to claim 1, further comprising a nail magazine that connects the bolt-guiding element to the support foot.

7. The nailing device according to claim 6, further comprising a pivot bearing which defines the pivot axis of the support foot is situated on the nail magazine.

8. The nailing device according to claim 7, wherein the pivot bearing is situated at an end of the nail magazine remote from the bolt-guiding element.

9. The nailing device according to claim 6, wherein the support foot is situated at an end of the nail magazine remote from the bolt-guiding element.

10. The nailing device according to claim 1, further comprising a frame hook which is pivotable together with the support foot about the pivot axis of the support foot.

11. The nailing device according to claim 1, wherein the support foot is pivotable about the pivot axis by at least 180°.

12. The nailing device of claim 4, wherein the support foot is lockable and unlockable in at least one pivot position.

13. The nailing device of claim 7, wherein the pivot bearing is fastened on the nail magazine.

14. The nailing device of claim 10, wherein the frame hook is fixedly connected to the support foot.

15. The nailing device according to claim 1, wherein the support foot is fixable and detachable, in at least one pivot position.

16. The nailing device according to claim 1, wherein the support foot is fixable and detachable, in at least one pivot position.

17. The nailing device according to claim 1, further comprising an overload mechanism comprising a pivot mechanism, wherein the support foot together with the overload mechanism is fastened to the nailing device, so that when a force that exceeds an overload force is applied to the support foot, the support foot is automatically detachable from the nailing device.

18. The nailing device according to claim 1, further comprising an overload mechanism comprising a pivot mechanism, wherein the support foot together with the overload mechanism is fastened to the nailing device, so that when a force that exceeds an overload force is applied to the support foot, the support foot is automatically detachable from the nailing device.

19. The nailing device according to claim 1, further comprising an overload mechanism comprising a pivot mechanism, wherein the support foot together with the overload mechanism is fastened to the nailing device, so that when a force that exceeds an overload force is applied to the support foot, the support foot is automatically detachable from the nailing device.

20. The nailing device according to claim 1, further comprising a nail magazine that connects the bolt-guiding element to the support foot.
